(19) United States
(12) Patent Application Publication
(10) Pub. No.: US 2010/0171718 A1
(43) Pub. Date: Jul. 8, 2010

(54) METHOD FOR MANUFACTURING TOUCH PANEL, TOUCH PANEL, DISPLAY DEVICE, AND ELECTRONIC APPARATUS

(75) Inventor: Atsushi DENDA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/651,626

(22) Filed: Jan. 4, 2010

(30) Foreign Application Priority Data
Jan. 8, 2009 (JP) 2009-002240

(51) Int. Cl. G06F 3/041; B05D 5/12

(52) U.S. Cl. 345/173; 427/97.3

(57) ABSTRACT

A method for manufacturing a touch panel including a substrate, a first electrode, and a second electrode, the first and second electrodes being formed on one side of the substrate in a plural numbers and extending in directions intersecting with each other, the method includes forming the first electrode and electrode films on the substrate, forming an insulating film by a printing method on at least an intersection of the first electrode with the second electrode, and forming a bridge wiring line connecting the electrode films over the insulating film by the printing method. In the method, each of the electrode films has a shape obtained by cutting off the second electrode at the intersection.

### BACKGROUND

1. Technical Field

The present invention relates to a method for manufacturing a touch panel, a touch panel, a display device, and an electronic apparatus.

2. Related Art

In capacitance touch screens, when a finger is brought close to a predetermined position of a panel in which electrodes are formed, capacitance is formed between the electrodes. The predetermined position is detected by detecting a current for charging the capacitance. As the capacitance touch screens, the followings are disclosed, for example.

JP-A-4-337824 is a first example of related art. In a coordinate input device disclosed in the first example, a substrate including X-electrodes and a substrate including Y-electrodes support a liquid crystal layer. Then, an electrode of a detection pen brought close to the substrate including the X-electrodes forms stray capacitance between the X- and Y-electrodes. A position of the detection pen is detected by a voltage induced when the stray capacitance is charged.

JP-A-6-318136 is a second example of related art. In an information input/output device disclosed in the second example, electrodes and an active element provided to each electrode are formed on the same substrate. The electrode is provided so as to correspond to each pixel of a display, and serves as a sensing electrode when a position is detected.

JP-A-9-305289 is a third example of related art. In a coordinate input device disclosed in the third example, X- and Y-electrodes intersecting with each other are respectively formed on a surface and a back surface of a sensor substrate. If a finger is brought close to the X-electrodes, a current is changed due to a change in an electric line of force toward the Y-electrodes from the X-electrodes. In this way, a position is detected.

JP-A-10-63403 is a fourth example of related art. In a coordinate input device disclosed in the fourth example, a plurality of electrodes intersecting with each other is provided with an insulating film interposed therebetween. Position detection is performed by detecting a current changed by a finger of operators brought close to the electrodes.

However, in the first to fourth examples above, when the electrodes extending in respective directions are formed or when the electrode and an active circuit are formed on the same substrate, a wiring layer is stacked by repeating sputtering, photolithography, etching, and the like several times. This disadvantageously results in increased manufacturing costs.

### SUMMARY

An advantage of the invention is to provide a method for manufacturing a touch panel, a touch panel, a display device, and an electronic apparatus that are capable of reducing manufacturing costs.

According to a first aspect of the invention, a method for manufacturing a touch panel including a substrate, a first electrode, and a second electrode, the first and second electrodes being formed on one side of the substrate in a plural numbers and extending in directions intersecting with each other, the method includes forming the first electrode and electrode films on the substrate, forming an insulating film by a printing method on at least an intersection of the first electrode with the second electrode, and forming a bridge wiring line connecting the electrode films over the insulating film by the printing method. In the method, each of the electrode films has a shape obtained by cutting off the second electrode at the intersection.

According to the first aspect, the first electrode and the electrode films to serve as the second electrode are formed in the same step, and the bridge wiring line connecting the electrode films is formed by the printing method. In this way, the number of steps for forming the first and second electrodes can be reduced. As a result, it is possible to provide a method for manufacturing a touch panel capable of reducing manufacturing costs.

In the method for manufacturing a touch panel, the first and second electrodes may respectively have a plurality of island-shaped electrode portions and a bridge wiring line connecting the island-shaped electrode portions adjacent to each other while the bridge wiring line of the first electrode intersects with the bridge wiring line of the second electrode. In forming the first electrode and the electrode films, the first electrode and the island-shaped electrode portions of the second electrode are preferably formed. In forming the insulating film, the insulating film is preferably formed on at least the bridge wiring line of the first electrode. In forming the bridge wiring line, the bridge wiring line of the second electrode is preferably formed. According to the method, the first electrode and the island-shaped electrode portions of the second electrode are formed in the same step and the bridge wiring line is formed by the printing method. In this way, the number of steps for forming the first and second electrodes can be reduced. As a result, it is possible to provide a method for manufacturing a touch panel capable of reducing manufacturing costs.

In forming the first electrode and the electrode films, the island-shaped electrode portions having a rectangular shape in a plan view are preferably formed in a matrix while the bridge wiring line connecting corners of the island-shaped electrode portions of the first electrodes is formed. In forming the bridge wiring line, the bridge wiring line connecting corners of the island-shaped electrode portions of the second electrodes is preferably formed. According to the method, a planar area of the intersection of the bridge wiring lines is minimized. Thus, it is possible to provide a method for manufacturing a touch panel in which the first and second electrodes intersect with each other with the shortest bridge wiring line.

In forming the insulating film, the insulating film having a constricted planar shape at a position at which the bridge wiring line of the second electrode to be formed is preferably formed. In this way, the insulating film located at the sides of the constricted area prevents a forming material of the bridge wiring line from spreading. Thus, is it possible to provide a method for manufacturing a touch panel that prevents miswiring of the bridge wiring lines.

After forming the first electrode and the electrode films, an auxiliary wiring line having lower sheet resistance than sheet resistance of the first and second electrodes is preferably stacked on the first and second electrodes extending from an input area of the touch panel. According to the method, since the auxiliary wiring line reduces wiring resistance of the wiring lines extending in the periphery of the input area, it is possible to provide a method for manufacturing a touch panel capable of reducing power consumption.

In forming the insulating film, a wiring protective film covering the auxiliary wiring line is preferably formed with the insulating film. According to the method, the insulating film and the wiring protective film are formed in the same step. In this way, the number of steps is reduced, and it is possible to provide a method for manufacturing a touch panel capable of reducing manufacturing costs.

After forming the bridge wiring line, a protective film is preferably formed on an area that is in the one surface of the substrate and includes at least an input area of the touch panel. According to the method, the first and second electrodes formed in the input area are protected. Thus, it is possible to provide a method for manufacturing a touch panel having a longer product life.

After forming one of the bridge wiring line and the protective film, a bonding layer that bonds one of a protective substrate and an optical element substrate with the substrate is formed on the area. According to the method, the first and second electrodes formed in the input area are securely protected by securely providing the protective film or the optical element substrate on the one side of the substrate. Thus, it is possible to provide a method for manufacturing a touch panel having a longer product life.

Prior to forming the first electrode and the electrode films, a conductive film and an insulating film covering the conductive film are preferably stacked on the one surface of the substrate. According to the method, noise from an opposite surface of the one side of the substrate can be blocked. Thus, it is possible to provide a method for manufacturing a touch panel that prevents a malfunction from occurring.

A conductive film is preferably formed on a surface opposite from the one surface of the substrate. According to the method, noise from the opposite surface of the one side of the substrate can be blocked. Thus, it is possible to provide a method for manufacturing a touch panel that prevents a malfunction from occurring.

A dummy electrode having substantially the same component as the first and second electrodes is preferably formed on an area between the first and second electrodes on the substrate. According to the method, a space between the first and second electrodes can be reduced. Consequently, it is possible to provide a method for manufacturing a touch panel capable of reducing visibility of wiring pattern of the first and second electrodes.

According to a second aspect of the invention, a touch panel includes a substrate, a first electrode, an insulating film, and a second electrode including electrode films and a bridge wiring line connecting the electrode films over the insulating film. In the device, the first and second electrodes are provided in plural numbers on the substrate and extend in directions intersecting with each other. Each of the electrode films has a shape obtained by cutting off the second electrode at an intersection with the first electrode. The insulating film is formed on at least the intersection with the first electrode.

According to the second aspect, the first and second electrodes are formed on the same surface of the substrate. In this way, the number of steps is reduced, and it is possible to provide a touch panel capable of reducing manufacturing costs. In addition, since the electrode films are formed on the same surface, it is possible to achieve an improvement of light transmittance as well as a thinner touch panel.

According to the touch panel, the first and second electrodes preferably respectively include a plurality of island-shaped electrode portions and a bridge wiring line connecting the island-shaped electrode portions adjacent to each other while the bridge wiring line of the first electrode intersects with the bridge wiring line of the second electrode. At the intersection, the insulating film is preferably formed on the bridge wiring line of the first electrode. The bridge wiring line of the second electrode preferably connects the island-shaped electrode portions of the second electrode over the insulating film. According to the structure, it is only necessary that the insulating film and the bridge wiring lines are partially formed. As a result, it is possible to provide a touch panel capable of reducing manufacturing costs.

The island-shaped electrode portions are preferably substantially rectangular in a plan view. The bridge wiring line of the first electrode preferably connects corners of the island-shaped electrode portions of the first electrode. The bridge wiring line of the second electrode preferably connects corners of the island-shaped electrode portions of the second electrode. According to the structure, a planar area of the intersection of the bridge wiring lines is minimized. As a result, it is possible to provide a touch panel in which the first and second electrodes intersect with each other with the shortest bridge wiring line.

The insulating film preferably has a constricted planar shape at a position at which the bridge wiring line of the second electrode is formed. In this way, the insulating film located at the sides of the constricted area prevents a forming material of the bridge wiring line from spreading. Thus, is it possible to provide a touch panel that prevents miswiring of the bridge wiring lines.

An auxiliary wiring line having lower sheet resistance than sheet resistance of the first and second electrodes is preferably stacked on the first and second electrodes extending from an input area of the touch panel. Accordingly, since the auxiliary wiring line reduces wiring resistance of the wiring lines extending in the periphery of the input area, it is possible to provide a touch panel capable of reducing power consumption.

A wiring protective film containing the same component as the insulating film is preferably formed so as to cover the auxiliary wiring line. According to the structure, the insulating film and the wiring protective film are formed in the same step. In this way, the number of steps is reduced, and it is possible to provide a touch panel capable of reducing manufacturing costs.

A protective film covering at least the first and second electrodes in an input area of the touch panel is preferably provided. According to the structure, the first and second electrodes formed in the input area are protected. Thus, it is possible to provide a touch panel having increased reliability.

A bonding layer is preferably formed so as to cover at least the first and second electrodes in the input area, and one of a protective substrate and an optical element substrate is preferably bonded to the protective film with the bonding layer interposed therebetween. According to the structure, the first and second electrodes formed in the input area are securely protected by securely providing the protective film or the optical element substrate on the one side of the substrate. Thus, it is possible to provide a touch panel having enhanced reliability.

A conductive film and an insulating film covering the conductive film are preferably formed on the one side of the substrate, and the first and second electrodes are preferably formed on the insulating film covering the conductive film. According to the structure, noise from the opposite surface of the one side of the substrate can be blocked. Thus, it is possible to provide a touch panel that prevents a malfunction from occurring.

A conductive film is formed on a surface opposite from the one surface of the substrate. Accordingly, noise from the opposite surface of the one side of the substrate can be blocked. Thus, it is possible to provide a touch panel that prevents a malfunction from occurring.

In the touch panel, the substrate is preferably a substrate of a display device. In this way, the electrodes for the touch panel and that for the display device can be formed on the same substrate. As a result, it is possible to providing a touch panel capable of reducing manufacturing costs.

According to a third aspect of the invention, a display device includes the touch panel according to the second aspect. Thus, the touch panel manufactured with low costs is used in the display device, being able to reduce manufacturing costs of the display device.

According to a fourth aspect of the invention, an electronic apparatus includes at least one of the touch panel according to the second aspect and the display device according to the third aspect. Accordingly, the touch panel or the display device manufactured with low costs is used in the electronic apparatus, being able to reduce manufacturing costs of the electronic apparatus.

### BRIEF DESCRIPTION OF THE DRAWINGS

The invention will be described with reference to the accompanying drawings, wherein like numbers reference like elements.

FIG. 1 is a schematic plan view of a touch panel 100.

FIG. 2 is a schematic sectional view of the touch panel 100.

FIG. 3 is a schematic sectional view of a touch panel 100A.

FIG. 4 is a flowchart showing a method for manufacturing a touch panel.

FIG. 5 is a perspective view schematically showing a droplet discharge device IJ.

FIG. 6 is a diagram for explaining a liquid material discharging principal.

FIGS. 7A through 7D are process drawings showing a manufacturing process of the touch panel 100.

FIGS. 8A through 8C are process drawings showing the manufacturing process of the touch panel 100.

FIGS. 9A through 9C are schematic diagrams of droplets provided to an intersection.

FIGS. 10A through 10C are schematic diagrams of droplets provided to the intersection.

FIG. 11 is a schematic plan view of a touch panel 200.

FIG. 12 is a schematic sectional view of the touch panel 200.

FIG. 13A is a schematic plan view and FIG. 13B is a schematic sectional view of a liquid crystal display device 500.

FIG. 14 is a perspective view showing an example of an electronic apparatus according to the invention.

### DESCRIPTION OF EXEMPLARY EMBODIMENTS

Embodiments of a touch panel, a method for manufacturing the same, a display device, and an electronic apparatus according to the invention will be described with reference to the accompanying drawings. These embodiments of the invention are shown by way of example, and not intended to limit the invention. It is understood that various modifications can be made as long as it falls within the main technical scope of the invention. Note that in order to facilitate the explanation of each structure, the scale and the number of components in each structure are different from those of an actual structure in the drawings below.

### First Embodiment

### Touch Panel

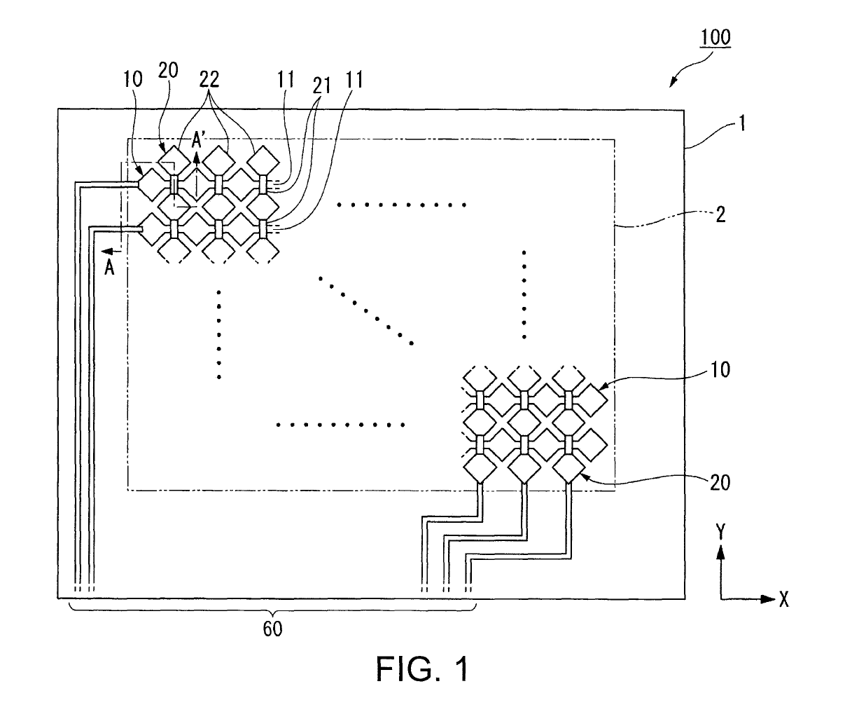

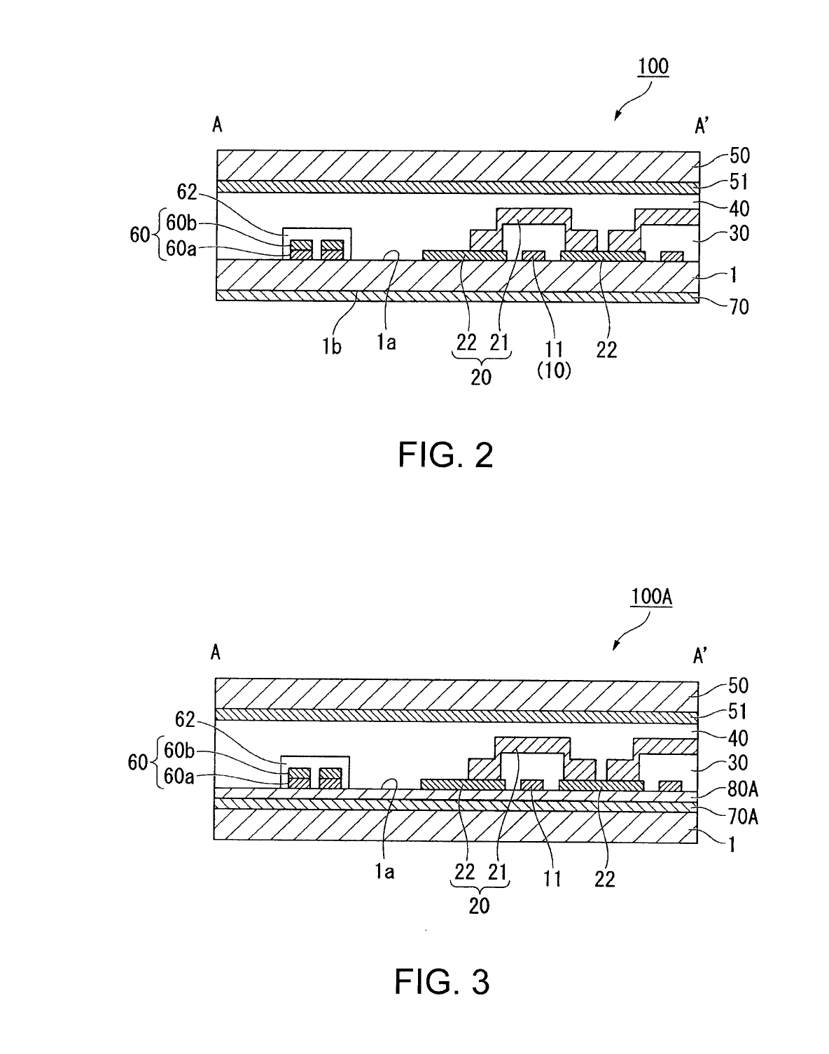

FIG. 1 is a schematic plan view showing a touch panel 100 according a first embodiment of the invention. FIG. 2 is a sectional view taken along the line A-A′ of the touch panel 100.

The touch panel 100 includes a substrate 1, an input area 2, and interconnection wiring lines 60. The substrate 1 is formed in a rectangular shape in a plan view, and is made of a transparent material such as glass or acrylic resin.

The input area 2 is an area enclosed by dashed lines in FIG. 1, and detects positional information on a finger that brought close to the touch panel. In the input area 2, a plurality of X-electrodes 10 and a plurality of Y-electrodes 20 are respectively arranged. In the drawing, each of the X-electrodes 10 extends in an X-axis direction and the plurality of X-electrodes 10 is arranged along a Y-axis direction, whereas each of the Y-electrodes 20 extends in the Y-axis direction and the plurality of Y-electrodes 20 is arranged along the X-axis direction. A bridge wiring line of the X-electrode 10 intersects with that of the Y-electrode 20 so that the X-electrode 10 intersects with the Y-electrode 20 in the input area 2.

The X-electrode 10 includes a plurality of island-shaped electrode portions 12 arranged in the X-axis direction and a bridge wiring line 11 connecting the island-shaped electrode portions 12 adjacent to each other. Each of the island-shaped electrode portions 12 is formed in a rectangular shape in a plan view, and arranged such that one diagonal line thereof is along the X-axis.

The Y-electrode 20 includes a plurality of island-shaped electrode portions 22 arranged in the Y-axis direction and a bridge wiring line 21 connecting the island-shaped electrode portions 22 adjacent to each other. Each of the island-shaped electrode portions 22 is formed in a rectangular shape in a plan view, and arranged such that one diagonal line thereof is along the Y-axis. The island-shaped electrode portions 21 and 22 are alternatively arranged (in a checkered pattern) in the X-axis and Y-axis directions, so that the island-shaped electrode portions 21 and 22 having a rectangular shape are arranged in a matrix in a plan view in the input area 2.

The X- and Y-electrodes 10 and 20 can be formed of a resistant material having translucency such as indium tin oxide (ITO), indium zinc oxide (IZO; registered trademark), or ZnO.

The interconnection wiring lines 60 are coupled to the X- and Y-electrodes 10 and 20 as well as a drive unit and an electrical signal conversion/calculation unit (all not shown) provided inside of the touch panel 100 or an external device.

The sectional view of FIG. 2 will be described. The island-shaped electrode portions 12 (not shown), the island-shaped electrode portions 22, and the bridge wiring line 11 are provided on a functional surface 1a of the substrate 1. Formed on the bridge wiring line 11 is an insulating film 30. Provided on the insulating film 30 is the bridge wiring line 21. Additionally, provided on the functional surface 1a of the substrate 1 are interconnection wiring lines 60. Each of the interconnection wiring lines 60 includes a first layer 60a provided on the functional surface 1a and a second layer 60b stacked on the first layer 60a. Covering the interconnection wiring lines 60, a wiring protective film 62 is formed. Covering these electrodes and wiring lines, a planarization film 40 is formed. Provided on the planarization film 40 is a protective substrate 50 with a bonding layer 51 interposed therebetween. Provided on a back surface 1b of the substrate 1 is a shield layer 70.

The insulating film 30 isolates the bridge wiring line 11 from the bridge wiring line 21. The bridge wiring lines 11 and 21 three-dimensionally intersect with each other. The insulating film 30 is formed by applying polysiloxane, acrylic resin, acrylic monomer, or the like by a printing method, and then dried and solidified. In a case where polysiloxane is used, the insulating film 30 is an inorganic insulating film formed of silicon oxide. On the other hand, acrylic resin or acrylic monomer is used, the insulating film 30 is an organic insulating film formed of a resin material.

It is preferable that the insulating film 30 is formed of a material whose specific inductive is 4.0 or less and more preferably 3.5 or less. In this way, parasitic capacitance on the intersection of the bridge wiring lines is reduced, so that it is possible to maintain positional detection performance of a touch panel. Further, it is preferable that the insulating film 30 is formed of a material whose refractive index is 2.0 or less and more preferably 1.7 or less. Accordingly, it is possible to reduce a difference in refractive index between the insulating film 30 and the substrate 1, the insulating film 30 and the X-electrode 10, and the insulating film 30 and the Y-electrode 20. As a result, a pattern of the insulating film 30 cannot be seen by users.

The first layer 60a of the interconnection wiring line 60 is the X-electrode 10 or the Y-electrode 20 outwardly extended from the input area 2, and is formed of a resistant material such as ITO or IZO. The second layer 60b is stacked on the first layer 60a, reducing wiring resistance of the interconnection wiring line 60. The second layer 60b can be formed of organic compounds, nanoparticles, or nanowires that have one or more component selected from metal, such as Au, Ag, Al, Cu, or Pd, and carbon (graphite or nano-carbon such as carbon nanotube). A material for the second layer 60b is not particularly limited as long as sheet resistance of the second layer 60b is less than that of the first layer 60a.

The wiring protective film 62 covering the interconnection wiring line 60 can be formed of polysiloxane, acrylic resin, acrylic monomer, or the like by the printing method in the same manner as the insulating film 30. Therefore, the wiring protective film 62 can be simultaneously formed with the insulating film 30.

The planarization film 40 is formed so as to cover at least the input area 2 of the functional surface 1a of the substrate 1, planarizing unevenness of the functional surface 1a formed by the X- and Y-electrodes 10 and 20. As shown in the drawing, the planarization film 40 is preferably formed so as to cover substantially the entire surface of the functional surface 1a (except for an external connection terminal unit). The planarization film 40 planarizes the functional surface 1a side of the substrate 1. This makes it possible to evenly bond substantially the entire surfaces of the substrate 1 and the protective substrate 50. In addition, it is preferable that the planarization film 40 is formed of a material whose refractive index is 2.0 or less and more preferably 1.7 or less. In this way, the difference in refractive index between the substrate 1 and the X-electrode 10 and between the substrate 1 and the Y-electrode 20 can be reduced, so that wiring patterns of the X- and Y-electrodes 10 and 20 can be less visible.

The protective substrate 50 is a transparent substrate made of glass or plastic, for example. Alternatively, in a case where the touch panel 100 of the embodiment is provided at a front surface of a display device such as a liquid crystal panel or an organic EL panel, as the protective substrate 50, it is possible to use an optical element substrate (such as a polarization plate or a phase difference plate) used as a portion of the display device.

The shield layer 70 is formed by depositing a transparent conductive material, such as ITO or IZO, on the back surface 1b of the substrate 1. Alternatively, a film, on which a transparent conductive film serving as the shield layer is formed, may be bonded to the back surface 1b of the substrate 1. The shield layer 70 blocks an electric field at the back surface 1b of the substrate 1. Accordingly, an electric field of the touch panel 100 is prevented from acting on the display device and the like. In the meantime, an electric field of an external apparatus, such as the display device, is prevented from acting on the touch panel 100.

Though the shield layer 70 is formed on the back surface 1b of the substrate 1 in the embodiment, as shown in FIG. 3, the shield layer may be formed on the functional surface 1a side of the substrate 1. FIG. 3 is a schematic sectional view of a touch panel 100A according to a modification of the first embodiment. In the touch panel 100A shown in FIG. 3, a shield layer 70A is formed on the functional surface 1a of the substrate 1, and an insulating film 80A covering the shield layer 70A is formed. The structure above the insulating film 80A is the same as that of the touch panel 100 shown in FIG. 2. In the touch panel 100A, the shield layer 70A, the X-electrode 10, the Y-electrode 20, the interconnection wiring line 60, and the like are formed on one side of the substrate 1. Thus, the manufacturing process does not become complex, allowing a touch panel to be highly manufacturable.

Here, the operation principle of the touch panel 100 will be briefly described. In the drawing, a predetermined potential is supplied from the drive unit (not shown) to the X- and Y-electrodes 10 and 20 via the interconnection wiring line 60. A ground potential, for example, is applied to the shield layer 70.

If a finger is brought close to the input area 2 from the protective substrate 50 side while the potential is supplied as above, parasitic capacitance is formed between the finger brought close to the protective substrate 50 and the respective X- and Y-electrodes 10 and 20 that are in close proximity to the contacted position. This results in a temporal decrease in the potential in the X- and Y-electrodes 10 and 20, in which the parasitic capacitance is formed, in order to charge the parasitic capacitance.

The drive unit senses the potential of each electrode, immediately detecting the X- and Y-electrodes 10 and 20 whose potential is decreased. The electrical signal conversion/calculation unit analyzes positions of the detected electrodes so as to detect positional information on the finger in the input area 2. To be specific, the X-electrode 10 extending in the X-axis direction detects Y-coordinate of the position in the input area 2 that the finger is brought close while the Y-electrode 20 extending in the Y-axis direction detects X-coordinate in the input area 2.

Method for Manufacturing a Touch Panel

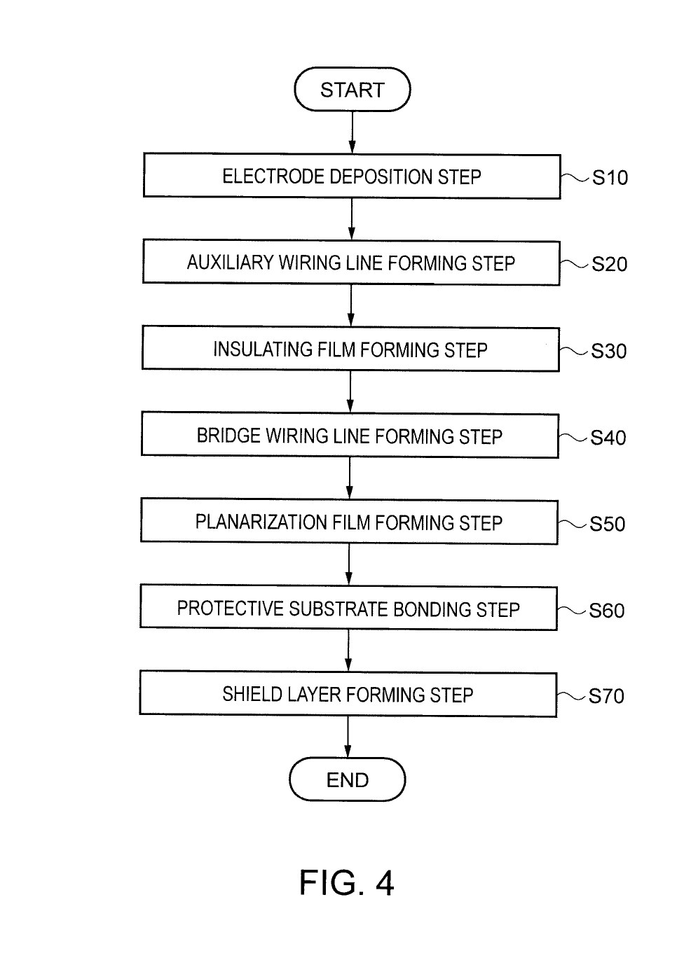

A method for manufacturing a touch panel will be described. In the present embodiment, a method for manufacturing the touch panel 100 shown in FIGS. 1 and 2 will be described with reference to the accompanying drawings. FIG. 4 is a flowchart showing the method for manufacturing a touch panel.

As shown in FIG. 4, the manufacturing process of a touch panel of the embodiment includes: an electrode deposition step S10 in which the island-shaped electrode portions 12 and 22, the bridge wiring line 11, and the first layer 60a of the interconnection wiring line 60 are formed on the functional surface 1a of the substrate 1; an auxiliary wiring line forming step S20 in which the second layer 60b is stacked on the first layer 60a of the interconnection wiring line 60; an insulating film forming step S30 in which the insulating film 30 is formed on the bridge wiring line 11 while the wiring protective film 62 is formed by covering the interconnection wiring line 60; a bridge wiring line forming step S40 in which the bridge wiring line 21 connecting the island-shaped electrode portions adjacent to each other is formed over the insulating film 30; a planarization film forming step (a protective film forming step) S50 in which the planarization film 40 planarizing the functional surface 1a side of the substrate 1 is formed; a protective substrate bonding step (a bonding layer forming step) S60 in which the protective substrate 50 is bonded to the planarization film 40 with the bonding layer 51 interposed therebetween; and a shield layer forming step (a conductive film forming step) S70 in which the shield layer 70 is formed on the back surface 1b of the substrate 1.

The manufacturing process of the touch panel 100 of the embodiment includes a deposition step employing a droplet discharge method, which is one of methods of the printing method. Consequently, a droplet discharge device will be described prior to the method for manufacturing a touch panel.

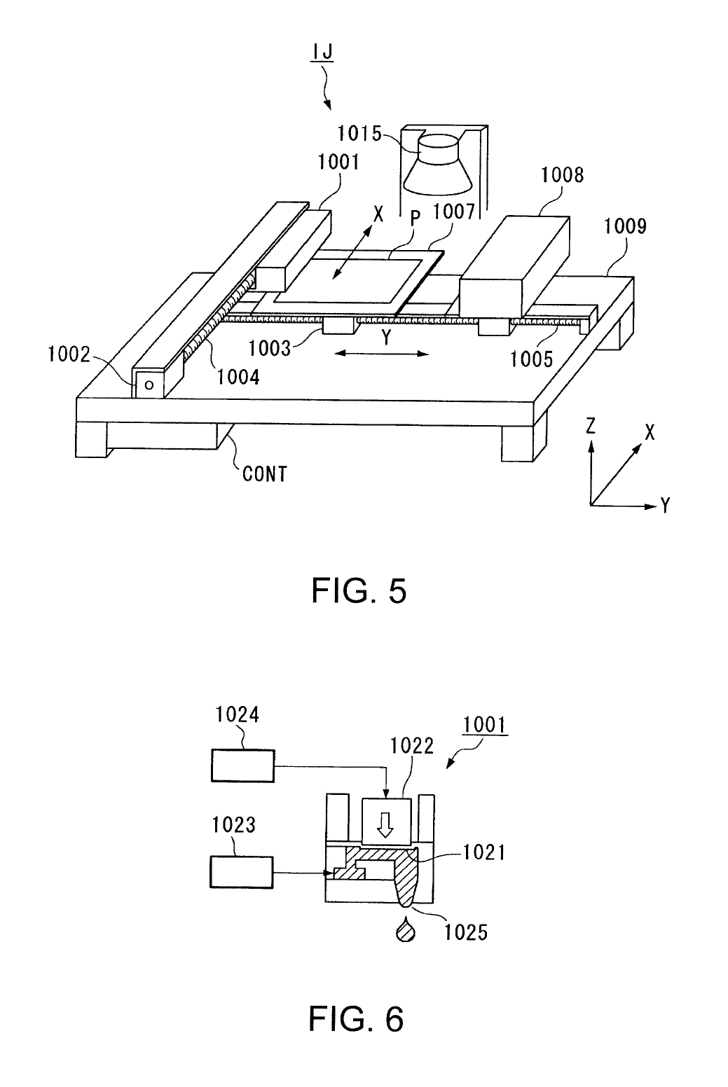

FIG. 5 is a perspective view schematically showing a droplet discharge device IJ. The droplet discharge device IJ includes a droplet discharge head 1001, an X-axis direction drive axis 1004, a Y-axis direction guide axis 1005, a controller CONT, a stage 1007, a cleaning mechanism 1008, a base 1009, and a heater 1015. In the embodiment, a droplet discharge device with electromechanical conversion using a piezo element (piezoelectric element) is used as a device discharging droplets.

The stage 1007 supports a substrate P to which a liquid material (a wiring pattern ink) is provided by the droplet discharge device IJ, and includes a fixing mechanism (not shown) for fixing the substrate P to a reference position.

The droplet discharge head 1001 is a multi-nozzle type droplet discharge head including a plurality of discharge nozzles. The longitudinal direction of the droplet discharge head 1001 corresponds to the X-axis direction. The plurality of discharge nozzles is disposed on a lower surface of the droplet discharge head 1001 with a constant interval. From the discharge nozzles of the droplet discharge head 1001, the wiring pattern ink containing conductive particulates is discharged on the substrate P supported by the stage 1007.

An X-axis direction drive motor 1002 is coupled to the X-axis direction drive axis 1004. The X-axis direction drive motor 1002 is a stepping motor, for example, and rotates the X-axis direction drive axis 1004 when a drive signal of the X-axis direction is supplied from the controller CONT. The X-axis direction drive axis 1004 rotates so as to move the droplet discharge head 1001 in the X-axis direction.

The Y-axis direction guide axis 1005 is fixed to the base 1009 so as not to move. The stage 1007 is equipped with a Y-axis direction drive motor 1003. The Y-axis direction drive motor 1003 is a stepping motor, for example, and moves the stage 1007 in the Y-axis direction when a drive signal of the Y-axis direction is supplied from the controller CONT.

The controller CONT supplies the droplet discharge head 1001 with a voltage for controlling a droplet discharge. The controller CONT also supplies the X-axis direction drive motor 1002 with a drive pulse signal for controlling a movement of the droplet discharge head 1001 in the X-axis direction, and the Y-axis direction drive motor 1003 with a drive pulse signal for controlling a movement of the stage 1007 in the Y-axis direction.

The cleaning mechanism 1008 cleans the droplet discharge head 1001. The cleaning mechanism 1008 is equipped with a drive motor (not shown) in the Y-axis direction. In accordance with an operation of the Y-axis direction drive motor, the cleaning mechanism moves along the Y-axis direction guide axis 1005. The controller CONT also controls the movement of the cleaning mechanism 1008.

The heater 1015, here, which is a device to subject the substrate P under a heat treatment by a lump annealing, evaporates and dries a solvent contained in a liquid material applied on the substrate P. The controller CONT also controls turning on and off of the heater 1015.

The droplet discharge device IJ discharges droplets from the plurality of droplet nozzles to the substrate P while relatively scanning the droplet discharge head 1001 and the stage 1007 supporting the substrate P.

FIG. 6 is a diagram for explaining the liquid material discharging principal by a piezo method. In FIG. 6, a piezo element 1022 is disposed adjacent to a liquid chamber 1021 storing the liquid material (the wiring pattern ink or a function liquid). To the liquid chamber 1021, the liquid material is supplied through a liquid material supply system 1023 that includes a material tank storing the liquid material. The piezo element 1022 is coupled to a drive circuit 1024. Through this drive circuit 1024, a voltage is applied to the piezo element 1022, thereby deforming the piezo element 1022. Thus, the liquid chamber 1021 is deformed to discharge the liquid material from a discharge nozzle 1025. In this case, a strain amount of the piezo element 1022 is controlled by changing a value of the applied voltage. In addition, a strain velocity of the piezo element 1022 is controlled by changing a frequency of the applied voltage. The droplet discharge employing this piezoelectric method advantageously has less effect on a material composition since no heat is applied to the material.

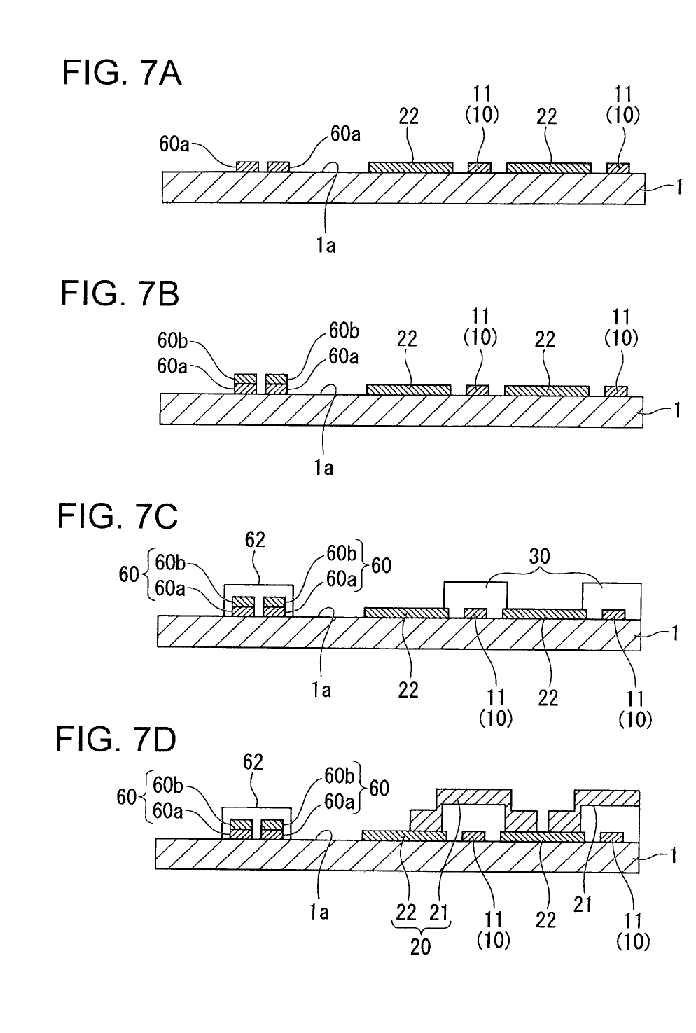

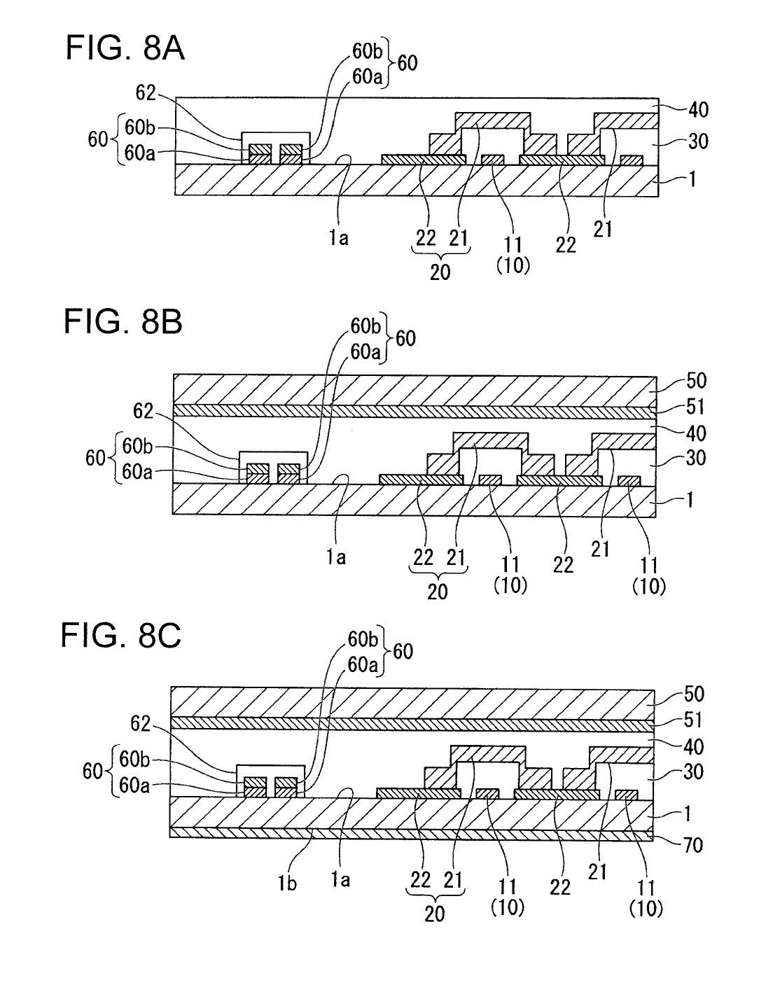

Returning now to the description of the method for manufacturing a touch panel. FIGS. 7A through 8C are diagrams showing the manufacturing process of the touch panel 100. These process drawings show steps for forming the structure shown in FIG. 2 (the intersection of the bridge wiring lines as well as the interconnection wiring line 60).

The electrode deposition step S10 will be described. In the electrode deposition step S10, droplets of a liquid material containing ITO particles, for example, are selectively provided on the substrate 1, which is a glass substrate, for example, by the droplet discharge device shown in FIG. 5. To be specific, the liquid material is disposed on the substrate 1 so as to form patterns of the X-electrode 10 having the island-shaped electrode portions 12 and the bridge wiring line 11, the island-shaped electrode portions 22 which are a portion of the Y-electrode 20, and the first layer 60a of the interconnection wiring line 60 extended from the island-shaped electrode portions 12 and 22. Subsequently, the liquid material (the droplets) provided on the substrate 1 is dried. Accordingly, as shown in FIG. 7A, the X-electrode 10 (the island-shaped electrode portions 12 and the bridge wiring line 11), the island-shaped electrode portions 22, and the first layer 60a, which are a collection of ITO particles, are formed on the substrate 1.

In the electrode deposition step S10 of the embodiment, an ITO film is formed by discharging droplets containing ITO particles. Besides, a transparent conductive film made of IZO may be formed by using droplets containing IZO particles. Further, in the electrode deposition step S10, the pattern may be formed by photolithography instead of the droplet discharge method. In other wards, after the ITO film is formed on substantially the entire surface of the functional surface 1a of the substrate 1 by sputtering, for example, the X-electrode 10 (the island-shaped electrode portions 12 and the bridge wiring line 11), the island-shaped electrode portions 22, and the first layer 60a may be formed by patterning the ITO film by photolithography and etching.

The step goes to the auxiliary wiring line forming step S20. In the auxiliary wiring line forming step 20, droplets of a liquid material containing a constituent material for the second layer 60b of the interconnection wiring line 60 are discharged on the first layer 60a by the droplet discharge device IJ. For example, a liquid material containing silver particles can be used for forming the second layer 60b. Thereafter, the droplets discharged are dried. Consequently, as shown in FIG. 7B, the second layer 60b, which is low-resistance, is formed on the first layer 60a, and the interconnection wiring line 60 having a double-layer structure is formed outside of the input area 2 on the substrate 1.

In addition to the liquid material containing silver particles, the second layer 60b may be formed of a liquid material containing metal particles, such as Au, Al, Cu, Pd, or a liquid material containing graphite or carbon nanotube, for example. Metal particles or carbon particles are dispersed in a liquid material in the form of nano particles or nanowires. In a case where the second layer 60b is a metal film, a liquid material containing an organic metallic compound may be used.

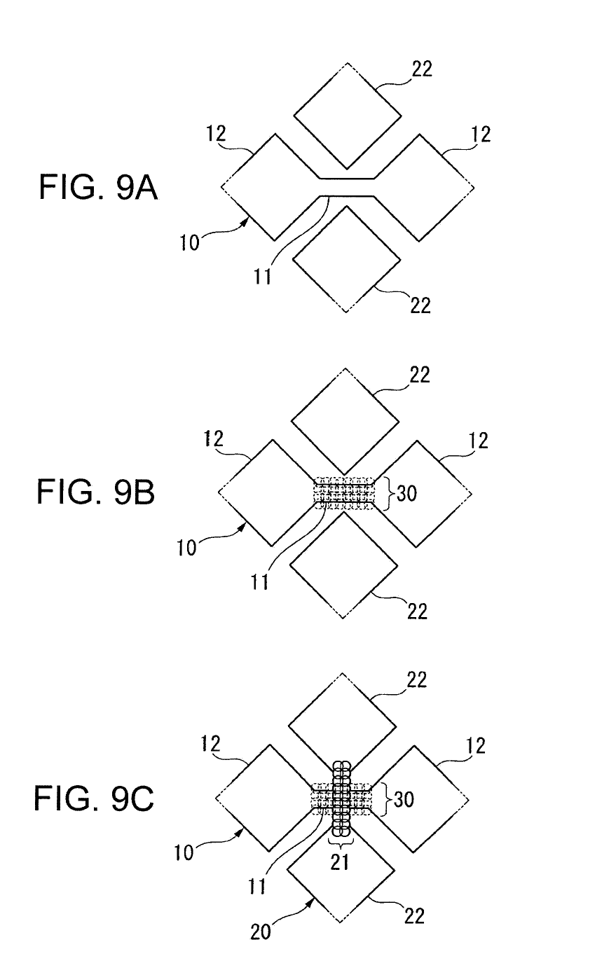

The insulating film forming step S30 and the bridge wiring line forming step S40 are sequentially performed. FIGS. 9A through 9C are explanatory diagrams specifically showing the insulating film forming step S30 and the bridge wiring line forming step S40. FIG. 9B is a plan view corresponding to FIG. 7C, and shows a forming region of the bridge wiring line 21. FIG. 9C is a plan view corresponding to FIG. 7D. The insulating film forming step S30 and the bridge wiring line forming step S40 will be described below with reference to FIGS. 7A through 7D and FIGS. 9A through 9C.

In the insulating film forming step S30, as shown in FIGS. 7C and 9B, droplets are selectively provided on an area on the bridge wiring line 11 of the X-electrode 10 by the droplet discharge device IJ. The liquid material on the substrate 1 is dried and solidified by heating, forming the insulating film 30 on the bridge wiring line 11. When the insulating film 30 is formed, as shown in FIG. 9B, droplets are preferably provided on the area on the bridge wiring line 11 without any gap. This results in forming the insulating film 30 having no holes or cracks that reach to the bridge wiring line 11. As a result, it is possible to prevent insulation failures of the insulating film 30 and disconnections of the bridge wiring line 21.

In addition to the area on the bridge wiring line 11, droplets are selectively provided on an area on the interconnection wiring line 60 as shown in FIG. 7C. The liquid material on the substrate 1 is dried and solidified by heating, forming the wiring protective film 62 covering the interconnection wiring line 60. For example, a liquid material containing polysiloxane or a liquid material containing acrylic resin or acrylic monomer can be used for forming the insulating film 30 and the wiring protective film 62.

The step goes to the bridge wiring line forming step S40. In the bridge wiring line forming step S40, as shown in FIGS. 7D and 9C, droplets of the liquid material containing ITO particles are provided in a wiring shape on the island-shaped electrode portions 22 provided adjacent to each other and the insulating film 30. Thereafter, the liquid material on the substrate 1 is dried and solidified. In this way, the bridge wiring line 21 connecting the island-shaped electrode portions 22 is formed. In addition to the above-described liquid material containing ITO particles, the bridge wiring line 21 may be formed of a liquid material containing IZO particles or ZnO particles.

It is preferable that the same liquid material used in the electrode deposition step S10 is preferably used in the bridge wiring line forming step S40 so as to form the bridge wiring line 21 as shown in FIG. 9C. That is, the bridge wiring line 21 is preferably formed of the same material as the X-electrode 10 and the island-shaped electrode portion 22.

The step goes to the planarization film forming step S50. In the planarization film forming step S50, as shown in FIG. 8A, the planarization film 40 formed of an insulating material is formed on substantially the entire surface of the functional surface 1a of the substrate 1 so as to planarize the functional surface 1a. The planarization film 40 can be formed of the same liquid material used to form the insulating film 30 in the insulating film forming step S30. However, since the planarization film 40 is formed so as to planarize the surface of the substrate 1, it is preferably formed of a resin material.

The step goes to the protective substrate bonding step S60. In the protective substrate bonding step S60, as shown in FIG. 8B, an adhesive is provided between the planarization film 40 and the protective substrate 50, which is separately prepared. The planarization film 40 and the protective substrate 50 are bonded together with the bonding layer 51 interposed therebetween. The bonding layer 51 is formed of the adhesive. In addition to the transparent substrate made of glass, plastic, or the like, the protective substrate 50 may be an optical element substrate such as a polarization plate or a phase difference plate. As the adhesive forming the bonding layer 51, a transparent resin material can be used, for example.

The step goes to the shield layer forming step S70. In the shield layer forming step S70, as shown in FIG. 8C, the shield layer 70 formed of a conductive film is formed on the back surface 1b (the surface opposite from the functional surface 1a) of the substrate 1. The shield layer 70 can be formed by the known film forming method, such as vacuum deposition, a screen printing method, an offset printing method, the droplet discharge method, or the like. For example, in a case where the shield layer 70 is formed by the printing method such as the droplet discharge method, it is possible to use the liquid material containing ITO particles or the like used in the electrode deposition step S10 and the bridge wiring line forming step S40. In addition to forming the shield layer 70 by depositing the substrate 1, a film having a conductive film formed on one or both surfaces thereof is separately prepared. The film may be bonded to the back surface 1b of the substrate 1 so that the conductive film on the film serves as the shield layer 70.

Though the shield layer 70 is formed at the end of manufacturing process of a touch panel in the embodiment, the shield layer 70 can be formed at an arbitrary timing. For example, the substrate 1 on which the shield layer 70 is preliminary formed may be used in steps succeeding the electrode deposition step S10. Alternatively, the shield layer forming step may be arbitrarily performed between the electrode deposition step S10 and the protective substrate bonding step S60.

In the embodiment, the shield layer 70 is formed on the back surface 1b of the substrate 1. However, if the shield layer 70A is formed on the functional surface 1a side of the substrate 1 as the touch panel 100A according to the modification in the first embodiment shown in FIG. 3, a step for forming the shield layer 70A and a step for forming the insulating film 80A are performed prior to the electrode deposition step S10. Also in this case, it is possible to form the shield layer 70A by the same method as the shield layer forming step S70. The step for forming the insulating film 80A is the same as the insulating film forming step S30, for example.

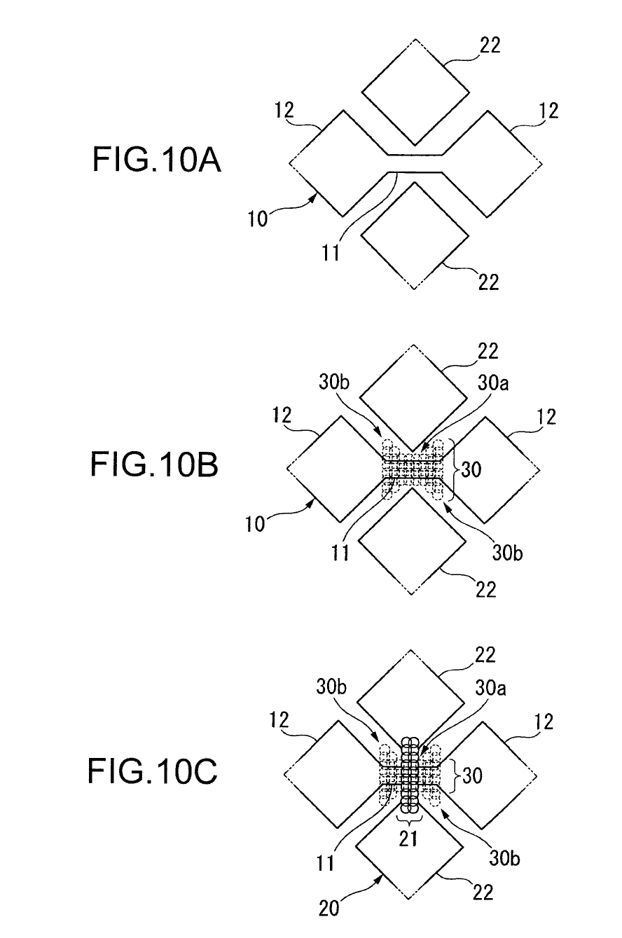

In the embodiment above, as shown in FIG. 9B, the insulating film 30 having substantially a rectangular shape in a plan view is formed in the insulating film forming step S30. However, the shape of the insulating film 30 may be changed so as to facilitate the formation of the bridge wiring line 21. FIGS. 10A through 10C are process drawings showing a manufacturing method according to the modification of the manufacturing method. FIGS. 10A through 10C respectively correspond to FIGS. 9A through 9C.

In the manufacturing method of the modification, as shown in FIG. 10B, the insulating film 30 having a partially constricted shape is formed in the insulating film forming step S30. To be more specific, a width of the insulating film 30 in the arrangement direction of the island-shaped electrode portions 22 (the extending direction of the Y-electrode 20) is formed narrow at a center portion 30a in the horizontal direction in the drawing (the extending direction of X the electrode 10) so that the insulating film 30 progressively becomes wider toward end portions 30b at both ends.

Subsequently, in the bridge wiring line forming process S40, the bridge wiring line 21 is formed so as to pass through the center portion 30a (the constricted portion) of the insulating film 30 as shown in FIG. 10C. According to such a manufacturing method, the end portions 30b function as a weir to prevent droplets from spreading when the droplets forming the bridge wiring line 21 are provided on the substrate 1. Consequently, short circuits between the bridge wiring line 21 and the X-electrode 10 can be effectively prevented, and the touch panel 100 can be manufactured with a high yield.

According to the method for manufacturing the touch panel 100 described in detail above, the following advantageous effects can be obtained. In the manufacturing method of the embodiment, the X-electrode 10 (the island-shaped electrode portions 12 and the bridge wiring line 11) and the island-shaped electrode portions 22 included in the Y-electrode 20 are formed on the same surface of the substrate 1. The insulating film 30 is formed by the droplet discharge method on the area on the bridge wiring line 11. Then, the bridge wiring line 21 connecting the island-shaped electrode portions 22 is formed by the droplet discharge method. The connecting structure of the Y-electrode 20 intersecting with the X-electrode 10 is formed by the droplet discharge method, so that the number of steps can be reduced compared with the related art manufacturing method. As a result, it is possible to reduce manufacturing costs of a touch panel.

To be more specific, in the related art process for forming the connection structure, the following steps are performed after the step shown in FIG. 7A. The process includes: a step for forming an interlayer insulating film for covering the X-electrode 10 and the island-shaped electrode portions 22; a step for forming contact holes in the interlayer insulating film so as to bridge the island-shaped electrode portions 22 adjacent to each other with the bridge wiring line; and a step for connecting the island-shaped electrode portions 22 by patterning the bridge wiring line in an area including the contact holes.

As is apparent from the comparison between the related art process and the process according to the embodiment, the photolithography step (and the etching step) for forming the contact holes in the interlayer insulating film as well as the photolithography step and the etching step for patterning the bridge wiring line in the related art process are unnecessary in the embodiment. Thus, according to the manufacturing method of the embodiment, the photolithography step, which is particularly costly, can be omitted, being able to reduce manufacturing costs of a touch panel. In addition, droplets are selectively provided by the manufacturing method on the area in which each film to be formed. This makes it possible to reduce an amount of the material to be used, thereby cutting manufacturing costs in cost of raw materials.

In the electrode deposition step S10 according to the manufacturing method of the embodiment, the X-electrode 10 and the island-shaped electrode portions 22 included in the Y-electrode 20 are formed by the droplet discharge method. Accordingly, the photolithography step and the etching step are also unnecessary in the electrode deposition step S10, being able to achieve a cost reduction by reducing the number of steps.

In the manufacturing method of the embodiment, the X-electrode 10 (the island-shaped electrode portions 12 and the bridge wiring line 11) and the island-shaped electrode portions 22 are formed on the same layer of the substrate 1. Accordingly, compared with the case where the X-electrode 10 and the Y-electrode 20 are respectively formed on separate layers with the interlayer insulating film interposed therebetween, the number of steps required for patterning the X-electrode 10 or the Y-electrode 20 can be reduced. As a result, it is possible to reduce manufacturing costs.

In the manufacturing method of the embodiment, the island-shaped electrode portions 12 and 22 having a rectangular shape are alternatively formed in a matrix on the substrate 1 so that the island-shaped electrode portions 12 adjacent to each other and the island-shaped electrode portions 22 adjacent to each other come close at their corners. Then, the corners of the island-shaped electrode portions 12 adjacent to each other are connected with the bridge wiring line 11 while the corners of the island-shaped electrode portions 22 adjacent to each other are connected with the bridge wiring line 21. In this way, the island-shaped electrode portions 12 adjacent to each other and the island-shaped electrode portions 22 adjacent to each other are connected at the shortest distance, allowing a distance of the bridge wiring lines 11 and 21 to be the shortest. This allows reducing the planar area of the intersection of the X-electrode 10 and the Y-electrode 20, so that the structure of the intersection can be hardly seen. Further, the length of the bridge wiring lines 11 and 21 having a narrow width can be shortened, being able to reduce wiring resistance of the X- and Y-electrodes 10 and 20. Though the shape of the island-shaped electrode portions 12 and 22 is rectangular (square) in a plan view in the embodiment, it may be a diamond shape, a polygonal shape, or a circle, for example.

In the manufacturing method according to the second modification, the insulating film 30 has a constricted shape in a plan view at the area on which the bridge wiring line 21 to be formed. Accordingly, the insulating film 30 located at the sides of the constricted area prevents the droplets forming the bridge wiring line 21 from spreading, so that is it possible to prevent miswiring, such as coupling the X-electrode 10 with the Y-electrode 20. As a result, a manufacturing yield of a touch panel can be improved. The touch panel 100 having such a structure enables a touch panel to be highly manufacturable.

In the touch panel 100 of the embodiment, the interconnection wiring line 60 formed in the periphery of the input area 2 includes the first layer 60a and the second layer 60b that are stacked. The first layer 60a is formed by extending the X- and Y-electrodes 10 and 20 while and the second layer 60b has smaller sheet resistance than that of the first layer 60a. This achieves a touch panel capable of reducing wiring resistance of the interconnection wiring line 60. As a result, a size of peripheral circuits such as a buffer circuit that amplifies signals from the input area 2 can be reduced, being able to reduce power consumption.

In the touch panel 100 of the embodiment, the wiring protective film 62 in the periphery of the input area 2 is preferably formed of a material containing the same component as that of the insulating film 30 formed at the intersection of the bridge wiring lines 11 and 21. In this way, it is possible to form the insulating film 30 and the wiring protective film 62 in the same step. As a result, the number of steps is reduced, allowing manufacturing costs to be reduced.

In the touch panel 100 of the embodiment, the planarization film 40 planarizes the functional surface 1a side of the substrate 1. With this structure, substantially the entire surfaces of the functional surface 1a side of the substrate 1 and the protective substrate 50 are bonded together, being able to prevent inclusion of bubbles to the bonding layer 51. In addition, the planarization film 40 protects the X- and Y-electrodes 10 and 20 formed on the substrate 1. Consequently, it is possible to manufacture a highly reliable touch panel.

The protective substrate 50 is bonded to the planarization film 40 with the bonding layer 51 interposed therebetween. Due to this structure, an air layer having a small refractive index does not exist between the protective substrate 50 and the planarization film 40. This prevents light from being reflected at an interface between the air layer and the protective substrate 50 or an interface between the air layer and the planarization film. As a result, high quality can be obtained as a touch panel provided at the front surface of the display device.

In the touch panel 100 of the embodiment, the shield layer 70 is formed on the back surface 1b of the substrate 1. The shield layer 70 blocks an unnecessary electric field, so that a noise is prevented from entering into the input area 2 of the touch panel 100 and an electric field of the touch panel 100 is prevented from leaking into the external apparatus side such as the display device.

### Second Embodiment

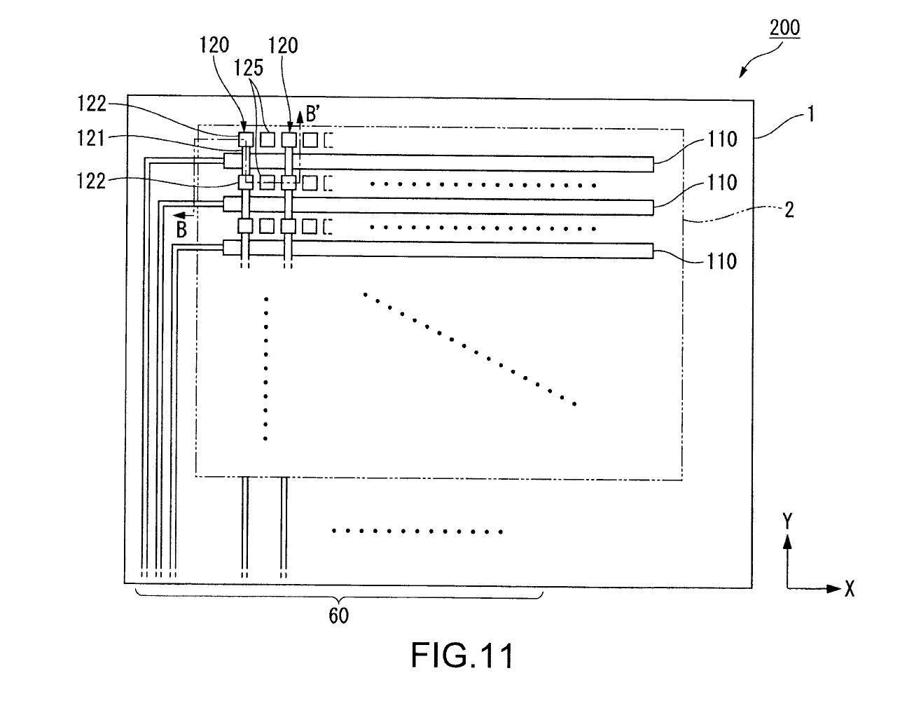

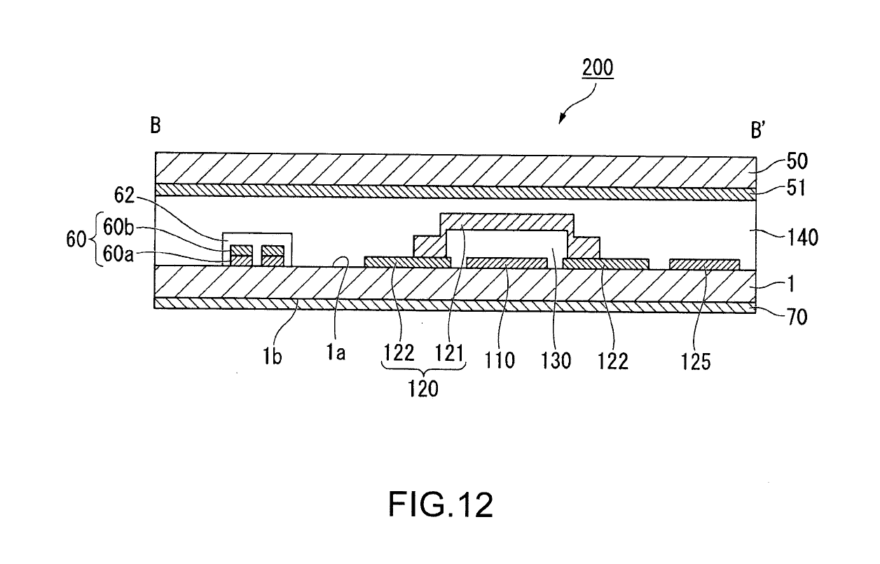

A touch panel according to a second embodiment of the invention will be described. FIG. 11 is a schematic sectional view showing a touch panel 200 according to the second embodiment of the invention. FIG. 12 is a schematic sectional view taken along the line B-B′ of the touch panel 200. In the present embodiment, detailed descriptions of portions having the same structure as those of the touch panels 100 and 100A shown in FIGS. 1 through 3 may be adequately omitted.

As shown in FIG. 11, the touch panel 200 includes the substrate 1, the input area 2, and the interconnection wiring lines 60.

The substrate 1 is formed in a rectangular shape in a plan view, and is made of a transparent material such as glass or acrylic resin.

The input area 2 is an area enclosed by dashed lines in FIG. 11, and detects positional information on a finger that brought close to the touch panel. In the input area 2, a plurality of X-electrodes 110 and a plurality of Y-electrodes 120 are respectively arranged. In the drawing, each of the X-electrodes 110 extends in the X-axis direction and the plurality of X-electrodes 110 is arranged along the Y-axis direction, whereas each of the Y-electrodes 120 extends in the Y-axis direction and the plurality of Y-electrodes 120 is arranged along the X-axis direction. A bridge wiring line 121 provided to the Y-electrode intersects with the X-electrode 110, so that the X-electrode 110 intersects with the Y-electrode 120 in the input area 2.

The X-electrode 110 is an electrode that has a rectangular shape and extends in the X-axis direction.

The Y-electrode 120 includes a plurality of island-shaped electrode portions 122 arranged in the Y-axis direction and a bridge wiring line 121 connecting the island-shaped electrode portions 122 adjacent to each other with the X-electrode 110 therebetween. Each of the island-shaped electrode portions 122 is formed in a rectangular shape in a plan view. Between the island-shaped electrode portions 122 adjacent to each other along the X-axis direction, a dummy electrode 125 is provided. That is, in the input area 2, the island-shaped electrode portions 122 and the dummy electrode 125 are alternatively provided along the X-axis direction.

The X-electrode 110, the Y-electrode 120, and the dummy electrode 125 can be formed of a resistant material having translucency, such as ITO, IZO, or ZnO.

The interconnection wiring lines 60 are coupled to the X- and Y-electrodes 110 and 120 as well as the drive unit and the electrical signal conversion/calculation unit (all not shown) provided inside of the touch panel 200 or the external device.

The sectional view of FIG. 12 will be described. The X-electrode 110, the island-shaped electrode portions 122, and the dummy electrode 125 are provided on the functional surface 1a of the substrate 1. Formed on the X-electrode 110 is an insulating film 130. Provided on the insulating film 130 is the bridge wiring line 121. Provided on the functional surface 1a of the substrate 1 are the interconnection wiring lines 60. Each of the interconnection wiring line 60 includes the first layer 60a and the second layer 60b that are stacked. Covering the interconnection wiring lines 60, the wiring protective film 62 is formed. Covering these electrodes and wiring lines, a planarization film 140 is formed. Provided on the planarization film 140 is the protective substrate 50 with the bonding layer 51 interposed therebetween. The shield layer 70 is provided on the back surface 1b of the substrate 1.

The insulating film 130 isolates the X-electrode 110 from the bridge wiring line 121. The X-electrode 110 and the bridge wiring line 121 three-dimensionally intersect with each other. The insulating film 130 is formed by applying polyciloxane, acrylic resin, acrylic monomer, or the like by the printing method and then dried and solidified.

The planarization film 140 is formed so as to cover at least the input area 2 of the functional surface 1a of the substrate 1, planarizing unevenness of the functional surface 1a formed by the X- and Y-electrodes 110 and 120.

The protective substrate 50 is a transparent substrate made of glass, plastic, for example. Alternatively, in a case where the touch panel 200 of the embodiment is provided at a front surface of a display device such as a liquid crystal panel or an organic EL panel, as the protective substrate 50, it is possible to use an optical element substrate (such as a polarization plate or a phase difference plate) used as a portion of the display device.

The shield layer 70 is formed by depositing a transparent conductive material, such as ITO or IZO, on the back surface 1b of the substrate 1. Alternatively, a film, on which a transparent conductive film serving as the shield layer is formed, may be bonded to the back surface 1b of the substrate 1.

Though the shield layer 70 is formed on the back surface 1b of the substrate 1, as shown in FIG. 3, the shield layer may be formed on the functional surface 1a side of the substrate 1 in the embodiment as well. In this case, the X-electrode 110, the Y-electrode 120, the dummy electrode 125, the interconnection wiring line 60, and the like are formed on the shield layer 70A and the insulating layer 80A that are stacked on the functional surface 1a of the substrate 1.

A method for manufacturing the touch panel 200 of the embodiment will be described with reference to the flowchart in FIG. 4. The electrode deposition step S10 through the shield layer forming step S70 in FIG. 4 are also performed in the manufacturing process of the touch panel 200.

In the electrode deposition step S10, droplets of the liquid material containing ITO particles are selectively provided on the substrate 1, which is a glass substrate, for example. To be specific, the liquid material is discharged on the substrate 1 so as to form patterns of the X-electrode 110, the island-shaped electrode portions 122 which are a portion of the Y-electrode 120, the dummy electrode 125, and the first layer 60a of the interconnection wiring line 60 extended from the X-electrode 110 and the island-shaped electrode portions 122. Subsequently, the liquid material (the droplets) provided on the substrate 1 is dried so as to form the X-electrode 110, the island-shaped electrode portions 122, the dummy electrode 125, and the first layer 60a.

The X-electrode 110, the island-shaped electrode portions 122, the dummy electrode 125, and the first layer 60a may be formed of a transparent conductive film made of IZO by discharging droplets containing IZO particles. The pattern may be formed by photolithography.

In the auxiliary wiring line forming step 20, droplets of the liquid material containing a constituent material for the second layer 60b of the interconnection wiring line 60 are discharged and provided on the first layer 60a. Subsequently, the droplets discharged are dried so as to form the second layer 60b.

In the insulating film forming step S30, droplets are selectively provided on a predetermined area on the X-electrode 110 as well as the interconnection wiring line 60. The liquid material on the substrate 1 is dried and solidified by heating, so that the insulating film 130 and the wring protective film 62 are formed. Also in the embodiment, the insulating film 130 may also be formed to have a constricted shape in a plan view at the area on which the bridge wiring line 121 to be formed.

In the bridge wiring line forming step S40, droplets of the liquid material containing ITO particles are provided in a wiring shape on the island-shaped electrode portions 122 provided adjacent to each other along the Y-axis direction and the insulating film 130. Subsequently, the liquid material on the substrate 1 is dried and solidified so as to form the bridge wiring line 121.

In the planarization film forming step S50, the planarization film 140 formed of an insulating material is formed on substantially the entire surface of the functional surface 1a of the substrate 1 so as to planarize the functional surface 1a.

In the protective substrate bonding step S60, an adhesive is provided between the planarization film 140 and the protective substrate 50, which is separately prepared. The planarization film 140 and the protective substrate 50 are bonded together with the bonding layer 51 interposed therebetween. The bonding layer 51 is formed of the adhesive. In addition to the transparent substrate made of glass, plastic, or the like, the protective substrate 50 may be an optical element substrate such as a polarization plate or a phase difference plate. As the adhesive included in the bonding layer 51, a transparent resin material can be used.

In the shield layer forming step S70, the shield layer 70 formed of a conductive film is formed on the back surface 1b (the surface opposite from the functional surface 1a) of the substrate 1.

According to the method for manufacturing the touch panel 200 described above, the following advantageous effects can be obtained. In the manufacturing method of the embodiment, the X-electrode 110 and the island-shaped electrode portions 122, which are included in the Y-electrode 120, are formed on the same surface of the substrate 1. The insulating film 130 is formed by the droplet discharge method on the area that is on the X-electrode 110 and connects the island-shaped electrode portions 122 adjacent to each other along the Y-axis direction. Then, the bridge wiring line 121 connecting the island-shaped electrode portions 122 is formed by the droplet discharge method. The connecting structure intersecting with the X-electrode 110 is formed by the droplet discharge method, so that the number of steps can be reduced compared with the related art manufacturing method. As a result, it is possible to reduce manufacturing costs of a touch panel.

In the electrode deposition step S10 according to the manufacturing method of the embodiment, the X-electrode 110, the island-shaped electrode portions 122 included in the Y-electrode 120, and the dummy electrode 125 are formed by the droplet discharge method. Accordingly, the photolithography step and the etching step are also unnecessary in the electrode deposition step S10, being able to achieve a cost reduction by reducing the number of steps.

In the manufacturing method of the embodiment, the X-electrode 110, the island-shaped electrode portions 122, and the dummy electrode 125 are formed on the same layer of the substrate 1. Accordingly, compared with the case where the X-electrode 110 and the Y-electrode 120 are respectively formed on separate layers with the interlayer insulating film interposed therebetween, the number of steps required for patterning the X-electrode 110, the Y-electrode 120, or the dummy electrode 125 can be reduced. As a result, it is possible to reduce manufacturing costs.

In the touch panel 200 of the embodiment, the dummy electrode 125 is provided between the island-shaped electrode portions 122 adjacent to each other. The dummy electrode 125 is formed of a resistant material which is equivalent to the X- and Y-electrodes 110 and 120. Since the resister made of the equivalent material as the X- and Y-electrodes 110 and 120 is provided to an area between the X- and Y-electrodes 110 and 120 in the input area 2, a refractive index of light and a reflection rate become uniform. Thus, wiring patterns of the X- and Y-electrode 110 and 120 cannot be seen by users.

In the manufacturing method according to the modification in the embodiment, the insulating film 130 has a constricted shape in a plan view at the area on which the bridge wiring line 121 to be formed. Accordingly, the insulating film 130 located at the sides of the constricted area prevents the droplets forming the bridge wiring line 121 from spreading, so that is it possible to prevent miswiring, such as coupling the X-electrode 110 with the Y-electrode 120. As a result, a manufacturing yield of a touch panel can be improved. The touch panel 200 having such a structure enables a touch panel to be highly manufacturable.

In the touch panel 200 of the embodiment, the interconnection wiring line 60 formed in the periphery of the input area 2 includes the first layer 60a and the second layer 60b that are stacked. The first layer 60a is formed by extending the X- and Y-electrodes 110 and 120 while the second layer 60b has smaller sheet resistance than that of the first layer 60a. This achieves a touch panel capable of reducing wiring resistance of the interconnection wiring line 60. As a result, a size of peripheral circuits such as a buffer circuit that amplifies signals from the input area 2 can be reduced, being able to reduce power consumption.

In the touch panel 200 of the embodiment, the wiring protective film 62 in the periphery of the input area 2 is preferably formed of a material containing the same component as that of the insulating film 130 formed at the intersection of the X-electrode 110 and the bridge wiring line 121. In this way, it is possible to form the insulating film 130 and the wiring protective film 62 in the same step. As a result, the number of steps is reduced, allowing manufacturing costs to be reduced.

In the touch panel 200 of the embodiment, the planarization film 140 planarizes the functional surface 1a side of the substrate 1. With this structure, substantially the entire surfaces of the functional surface 1a side of the substrate 1 and the protective substrate 50 are bonded together, being able to prevent inclusion of bubbles to the bonding layer 51. In addition, the planarization film 140 protects the X- and Y-electrodes 110 and 120 formed on the substrate 1. Consequently, it is possible to manufacture a highly reliable touch panel.

The protective substrate 50 is bonded to the planarization film 140 with the bonding layer 51 interposed therebetween. Due to this structure, an air layer having a small refractive index does not exist between the protective substrate 50 and the planarization film 140. This prevents light from being reflected at an interface between the air layer and the protective substrate 50 or an interface between the air layer and the planarization film. As a result, high quality can be obtained as a touch panel provided at the front surface of the display device.

In the touch panel 200 of the embodiment, the shield layer 70 is formed on the back surface 1b of the substrate 1. The shield layer 70 blocks an unnecessary electric field, so that a noise is prevented from entering into the input area 2 of the touch panel 200 and an electric field of the touch panel 200 is prevented from leaking into the external apparatus side such as the display device.

Display Device

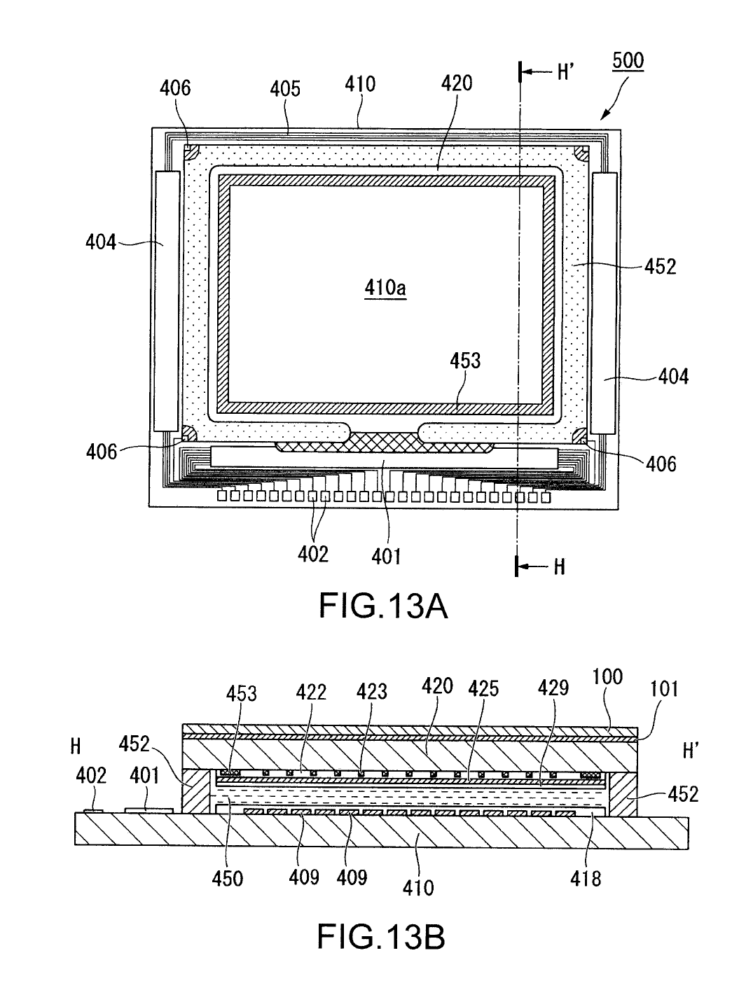

A display device equipped with the touch panel according to the invention will be described. In the present embodiment, a liquid crystal display device equipped with the touch panel is exemplified as the display device. FIGS. 13A and 13B are schematic views showing a liquid crystal display device 500 according to a third embodiment of the invention. FIG. 13A is a plan view and FIG. 13B is a sectional view taken along the line H-H′ of FIG. 13A.

As shown in FIG. 13A, the liquid crystal display device 500 includes an element substrate 410, a counter substrate 420, and an image display area 410a.

The element substrate 410 is a rectangular substrate having a larger planar area than the counter substrate 420.

The counter substrate 420 is a clear substrate made of glass, or acrylic resin, for example, and is disposed in the image display side of the liquid crystal display device 500. The counter substrate 420 is bonded to the center of the element substrate 410 with a sealant 452 interposed therebetween.

The image display area 410a is a planar area of the counter substrate 420 and an area within a periphery partition 453 provided along the inner periphery of the sealant 452.

The periphery of the counter substrate 420 of the element substrate 410 includes a data line drive circuit 401, scan line drive circuits 404, connection terminals coupled to the data line drive circuit 401 and the scan line drive circuits 404, wiring lines 405 for coupling the scan line drive circuits 404 oppositely provided with respect to the counter substrate 420, and the like.

The section of the liquid crystal display device 500 will be described.

On a surface of the element substrate 410 in a liquid crystal layer 450 side, pixel electrodes 409, an alignment film 418, and the like are stacked. On a surface of the counter substrate 420 in the liquid crystal layer 450 side, light shielding films (black matrixes) 423, color filters 422, a common electrode 425, an alignment film 429, and the like are stacked. The element substrate 410 and the counter substrate 420 support the liquid crystal layer 450. On an outer surface of the counter substrate 420 (the opposite side of the liquid crystal layer 450), the touch panel 100 of the invention is disposed with a bonding layer 101 interposed therebetween.

According to the liquid crystal display device described above, the following advantageous effects can be obtained. In the touch panel 100 provided to the liquid crystal display device 500, the electrode for detecting a position and the insulating film for intersecting the electrodes are formed by the droplet discharge method. Accordingly, manufacturing costs of a touch panel are reduced, so that it is possible to manufacture a liquid crystal display device capable of reducing manufacturing costs.

The touch panel provided to the liquid crystal display device may be the touch panel 100A of the first modification in the first embodiment or the touch panel 200 of the second embodiment. These touch panels are manufactured by the deposition step employing the droplet discharge method, thereby manufacturing costs are reduced. As a result, a reduction in manufacturing cost of the liquid display device can be attained.

In the liquid display device of the embodiment, each layer of the touch panel is preferably formed on the outer surface (the opposite side of the liquid crystal layer 450) of the counter substrate 420. In this way, the counter substrate 420 of the liquid crystal device and the substrate 1 of the touch panel can be commonly used. Consequently, manufacturing costs can be further reduced while a light weight liquid crystal device can be obtained.

In addition to the liquid crystal display device described in the embodiment, the touch panel of the invention can be preferably used in display devices such as an organic EL device or an electrophoretic display device.

Electronic Apparatus

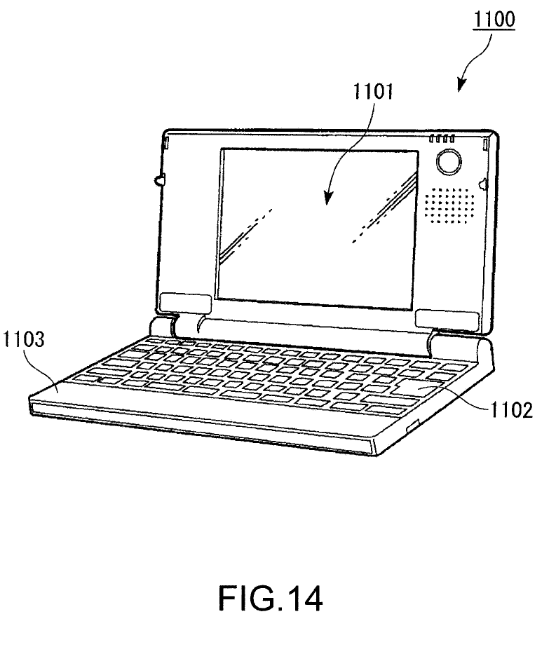

An electronic apparatus having the touch panel of the invention or the liquid crystal display device equipped with the touch panel will be described. FIG. 14 is a perspective view showing a mobile type personal computer 1100. The mobile type personal computer 1100 includes a display 1101 and a body 1103 having a keyboard 1102. The mobile type personal computer 1100 includes the above-described liquid crystal display device 500 in the display 1101. According to the mobile type personal computer 1100 having such a structure, the touch panel of the invention is used in the display. As a result, it is possible to achieve an electronic apparatus capable of reducing manufacturing costs.

The electronic apparatus described above only exemplifies the electronic apparatus of the invention, and does not intend to limit the invention. The touch panel of the invention can be preferably used in a display of cell phones, portable audio equipment, or personal digital assistants (PDA), for example.

The entire disclosure of Japanese Patent Application No. 2009-002240, filed Jan. 8, 2009 is expressly incorporated by reference herein.

1. A method for manufacturing a touch panel including a substrate, a first electrode, and a second electrode, the first and second electrodes being formed on one side of the substrate in a plural numbers and extending in directions intersecting with each other, the method comprising:
forming the first electrode and electrode films on the substrate;
forming an insulating film by a printing method on at least an intersection of the first electrode with the second electrode; and
forming a bridge wiring line connecting the electrode films over the insulating film by the printing method,
wherein each of the electrode films has a shape obtained by cutting off the second electrode at the intersection.

2. The method for manufacturing a touch panel according to claim 1, wherein the first and second electrodes respectively have a plurality of island-shaped electrode portions and a bridge wiring line connecting the island-shaped electrode portions adjacent to each other while the bridge wiring line of the first electrode intersects with the bridge wiring line of the second electrode,
wherein in forming the first electrode and the electrode films, the first electrode and the island-shaped electrode portions of the second electrode are formed,
wherein in forming the insulating film, the insulating film is formed on at least the bridge wiring line of the first electrode, and
wherein in forming the bridge wiring line, the bridge wiring line of the second electrode is formed.

3. The method for manufacturing a touch panel according to claim 2, wherein in forming the first electrode and the electrode films, the island-shaped electrode portions having a rectangular shape in a plan view are formed in a matrix while the bridge wiring line connecting corners of the island-shaped electrode portions of the first electrode is formed, and wherein in forming the bridge wiring line, the bridge wiring line connecting corners of the island-shaped electrode portions of the second electrode is formed.

4. The method for manufacturing a touch panel according to claim 2, wherein in forming the insulating film, the insulating film having a constricted planar shape at a position at which the bridge wiring line of the second electrode to be formed is formed.

5. The method for manufacturing a touch panel according to claim 1, wherein after forming the first electrode and the electrode films, an auxiliary wiring line having lower sheet resistance than sheet resistance of the first and second electrodes is stacked on the first and second electrodes extending from an input area of the touch panel.

6. The method for manufacturing a touch panel according to claim 5, wherein in forming the insulating film, a wiring protective film covering the auxiliary wiring line is formed with the insulating film.

7. The method for manufacturing a touch panel according to claim 1, wherein after forming the bridge wiring line, a protective film is formed on an area that is in the one surface of the substrate and includes at least an input area of the touch panel.

8. The method for manufacturing a touch panel according to claim 7, wherein after forming one of the bridge wiring line and the protective film, a bonding layer that bonds one of a protective substrate and an optical element substrate with the substrate is formed on the area.

9. The method for manufacturing a touch panel according to claim 1, wherein prior to forming the first electrode and the electrode films, a conductive film and an insulating film covering the conductive film are stacked on the one surface of the substrate.

10. A touch panel, comprising:
a substrate;
a first electrode;
an insulating film; and
a second electrode including:
electrode films; and
a bridge wiring line connecting the electrode films over the insulating film, wherein the first and second electrodes are provided in plural numbers on the substrate and extend in directions intersecting with each other,
wherein each of the electrode films has a shape obtained by cutting off the second electrode at an intersection with the first electrode, and wherein the insulating film is formed on at least the intersection with the first electrode.

11. The touch panel according to the claim 10, wherein the first and second electrodes respectively include a plurality of island-shaped electrode portions and a bridge wiring line connecting the island-shaped electrode portions adjacent to each other while the bridge wiring line of the first electrode intersects with the bridge wiring line of the second electrode,
wherein at the intersection, the insulating film is formed on the bridge wiring line of the first electrode, and
wherein the bridge wiring line of the second electrode connects the island-shaped electrode portions of the second electrode over the insulating film.

12. The touch panel according to claim 11, wherein the island-shaped electrode portions are substantially rectangular in a plan view, and the bridge wiring line of the first electrode connects corners of the island-shaped electrode portions of the first electrode while the bridge wiring line of the second electrode connects corners of the island-shaped electrode portions of the second electrode.

13. The touch panel according to claim 10, wherein the insulating film has a constricted planar shape at a position at which the bridge wiring line of the second electrode is formed.

14. The touch panel according to claim 10, wherein an auxiliary wiring line having lower sheet resistance than sheet resistance of the first and second electrodes is stacked on the first and second electrodes extending from an input area of the touch panel.

15. The touch panel according to claim 14, wherein a wiring protective film containing the same component as the insulating film is formed so as to cover the auxiliary wiring line.

16. The touch panel according to claim 10, wherein a protective film covering at least the first and second electrodes in an input area of the touch panel is provided.

17. The touch panel according to claim 16, wherein a bonding layer is formed so as to cover at least the first and second electrodes in the input area, and one of a protective substrate and an optical element substrate is bonded to the protective film with the bonding layer interposed therebetween.

18. The touch panel according to claim 10, wherein a conductive film and an insulating film covering the conductive film are formed on the one side of the substrate, and the first and second electrodes are formed on the insulating film covering the conductive film.

19. A display device comprising:
the touch panel according to claim 10.

20. An electronic apparatus comprising:
the touch panel according to claim 10.

21. An electronic apparatus comprising:
the display device according to claim 19.
